(19) United States
(12) Patent Application Publication
(10) Pub. No.: US 2026/0141641 A1
(43) Pub. Date: May 21, 2026

(54) TECHNIQUES FOR PERFORMING LOW-RANK SELF-CALIBRATION OF 3D GEOMETRIC FOUNDATION MODELS

(71) Applicant: NVIDIA CORPORATION, Santa Clara, CA (US)

(72) Inventors: Yue WANG, Los Angeles, CA (US); Danfei XU, Atlanta, GA (US); Heng YANG, Cambridge, MA (US); Boris IVANOVIC, Mountain View, CA (US); Boyi LI, New York, NY (US); Marco PAVONE, Stanford, CA (US); Ziqi LU, Cambridge, MA (US)

(21) Appl. No.: 19/236,674

(22) Filed: Jun. 12, 2025

Related U.S. Application Data
(60) Provisional application No. 63/721,336, filed on Nov. 15, 2024.

(51) Int. Cl. G06T 17/20; G06T 7/80; G06V 10/774; G06V 10/82

(52) U.S. Cl. CPC G06T 17/205; G06T 7/80; G06V 10/7753; G06V 10/82

(57) ABSTRACT

Techniques for performing low-rank self-calibration of 3D geometric foundation models include receiving a plurality of unlabeled images of a scene, generating a pair of point maps and a pair of confidence maps for a first pair of unlabeled images of the plurality of unlabeled images, determining intrinsic camera parameters for the first pair of unlabeled images, refining the pair of point maps based on the intrinsic camera parameters to generate a refined pair of point maps, generating pseudo-labels for the first pair of unlabeled images based on the refined pair of point maps and the pair of confidence maps, and fine tuning a pretrained machine learning model based on the pseudo-labels to generate a fine-tuned machine learning model.

### CROSS-REFERENCE TO RELATED APPLICATIONS

This application claims priority benefit of the U.S. Provisional Patent Application titled, “TECHNIQUES FOR PERFORMING LOW-RANK SELF-CALIBRATION OF 3D GEOMETRIC FOUNDATION MODELS,” filed on Nov. 15, 2024, and having Ser. No. 63/721,336. The subject matter of this related application is hereby incorporated herein by reference.

### BACKGROUND OF THE INVENTION

### Field of the Invention

Embodiments of the present disclosure relate generally to autonomous vehicle technology, three-dimensional mapping and environmental modeling, and artificial intelligence and, more specifically, to techniques for performing low-rank self-calibration of 3D geometric foundation models.

### Description of the Related Art

Three-dimensional (3D) scene reconstruction is the task of generating an accurate 3D representation of a scene from a set of two-dimensional (2D) images of the scene. 3D scene reconstruction has numerous applications in a wide variety of fields, including computer graphics and animation, and autonomous vehicle mapping and navigation.

Dense unconstrained stereo 3D reconstruction (DUSt3R) is a technique commonly used for 3D scene reconstruction from in-the-wild 2D images. In-the-wild 2D images are images with no information about the intrinsic or extrinsic camera parameters. Intrinsic camera parameters, such as focal length, are fixed to a particular camera setup, whereas extrinsic camera parameters define the location and orientation of the camera with respect to a particular coordinate system. DUSt3R uses a vision transformer network (ViT), trained in a fully supervised manner on labeled data, to estimate the intrinsic and extrinsic camera parameters and the geometry of a 3D scene from a pair of 2D images of that scene. For each input pair of 2D images of a scene, DUSt3R outputs two corresponding 3D point maps and confidence maps. The 3D scene parameters, including the scene geometry and the relation between pixels and scene points, can be recovered from the 3D point maps.

One drawback of this approach, however, is that this technique may fail to yield high-quality 3D reconstructions under circumstances of low visual overlaps, where certain regions are observed from only a single viewpoint, or low lighting. This failure is due, in part, to the difficulty of annotating in-the-wild 3D data, resulting in a shortage of high-quality labeled training datasets. The lack of high-quality labeled training datasets needed for the 3D geometric inferencing task limits the performance of this technique.

Another drawback is that training ViTs on large, labeled datasets can take a significant amount of time and consume large amounts of computing resources. As ViTs grow in size and complexity, the computational and memory costs and latencies associated with training and deploying ViTs for various user-end applications also increase. These increasing costs and latencies can limit the overall effectiveness and usefulness of this technique.

As the foregoing illustrates, what is needed in the art are more effective techniques for reconstructing 3D maps.

### SUMMARY

According to some embodiments, a computer-implemented method for generating a 3D environment map. The method includes receiving a plurality of unlabeled images of a scene, generating a pair of point maps and a pair of confidence maps for a first pair of unlabeled images of the plurality of unlabeled images, determining intrinsic camera parameters for the first pair of unlabeled images, refining the pair of point maps based on the intrinsic camera parameters to generate a refined pair of point maps, generating pseudo-labels for the first pair of unlabeled images based on the refined pair of point maps and the pair of confidence maps, and fine tuning a pretrained machine learning model based on the pseudo-labels to generate a fine-tuned machine learning model.

Further embodiments provide, among other things, non-transitory computer-readable storage media storing instructions and systems configured to implement the method set forth above.

At least one technical advantage of the disclosed techniques relative to the prior art is that, with the disclosed techniques, accurate reconstruction of 3D scenes can be generated from 2D images without having information about the intrinsic or extrinsic camera parameters. The disclosed techniques can generate accurate reconstruction of 3D scenes without manual labeling, eliminating the need to generate large labeled datasets to generate the reconstructed 3D scene. This allows the disclosed techniques to be used while new 2D images are being received from imaging devices and allows a 3D scene to be reconstructed based on these new 2D images. In addition, with the disclosed techniques accurate reconstruction of 3D scenes can be generated without having to train specialized neural models, which significantly reduces the computing resources used to generate the reconstructed 3D scene. These technical advantages represent one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a computer system configured to implement one or more aspects of the present invention,

FIG. 2 is a block diagram of a parallel processing unit included in the parallel processing subsystem of FIG. 1, according to various embodiments of the present invention;

FIG. 3 is a block diagram of a general processing cluster included in the parallel processing unit of FIG. 2, according to various embodiments of the present invention;

FIG. 4 is a block diagram of a computer-based system configured to implement one or more aspects of the various embodiments;

FIG. 5 is a more detailed description of the 3D scene reconstruction engine of FIG. 4, according to various embodiments;

FIG. 6 is a more detailed illustration of the point map optimization engine of FIG. 5, according to various embodiments;

FIG. 7 is a flow diagram of method steps for generating a reconstructed 3D scene, according to various embodiments; and

FIG. 8 is a flow diagram of method steps for using a reconstructed 3D scene, according to various embodiments.

### DETAILED DESCRIPTION

In the following description, numerous specific details are set forth to provide a more thorough understanding of the present invention. However, it will be apparent to one of skill in the art that the present invention may be practiced without one or more of these specific details.

Embodiments of the present disclosure provide techniques for reconstruction of a 3D scene from a set of unlabeled 2D images. First, for each pair of 2D images from a set of unlabeled 2D images, a pre-trained vision transformer generates a corresponding pair of point maps and confidence maps. Next, the point maps are optimized to refine multi-view predictions and calibrate prediction confidence. Then, the refined point maps with high calibrated prediction confidence are used to generate pseudo-labels for each pair of 2D images from the set of unlabeled 2D images. Each pair of pseudo-labeled 2D images is then used to fine-tune the pre-trained vision transformer, where a low rank decomposition is added to the weights of the pre-trained vision transformer. During fine-tuning, the low rank decomposition matrices are optimized, while the weights of the pre-trained vision transformer are frozen and do not receive gradient updates. For each new input pair of 2D images from the same scene, the fine-tuned vision transformer outputs point maps which are used to reconstruct a 3D scene that closely matches the originally collected unlabeled 2D images.

The techniques for performing low-rank self-calibration of 3D geometric foundation models have many real-world applications. For example, these techniques can be used in systems where 3D reconstruction of scenes using 2D images, such as vehicle navigation systems and/or the like, These techniques also have applications to computer graphics and animation, as well as archeology and cultural heritage preservation.

The above examples are not in any way intended to be limiting. As persons skilled in the art will appreciate, as a general matter, the techniques for performing low-rank self-calibration of 3D geometric foundation models that are described herein can be implemented in any application where 3D reconstruction of scenes using 2D images is required or useful.

### System Overview

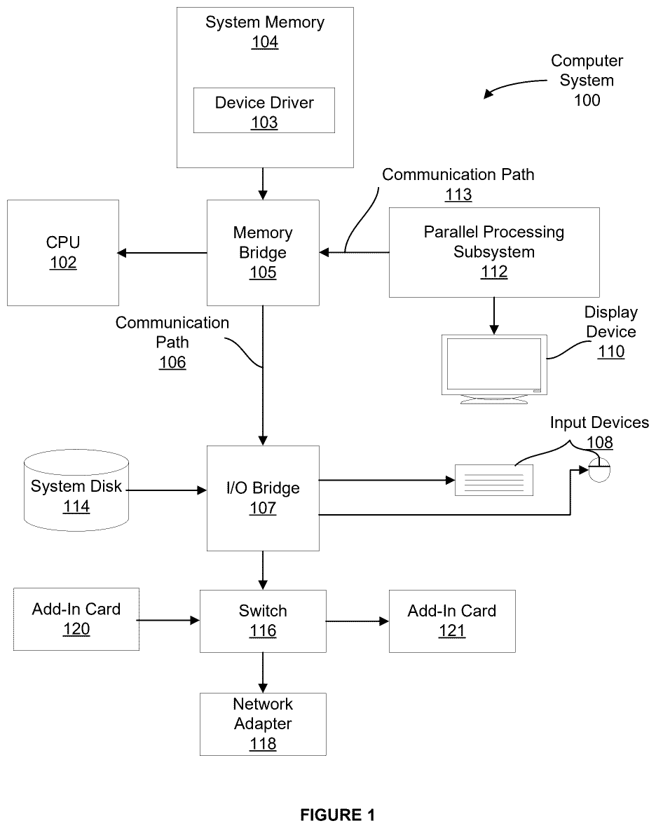

FIG. 1 is a block diagram of a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116. As persons skilled in the art will appreciate, computer system 100 can be any type of technically feasible computer system, including, without limitation, a server machine, a server platform, a desktop machine, laptop machine, or a hand-held/mobile device. Persons skilled in the art also will appreciate that computer system 100 or systems similar to computer system 100 can be incorporated into a vehicle or machine to facilitate driving, steering, or otherwise controlling that vehicle or machine, as the case may be.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

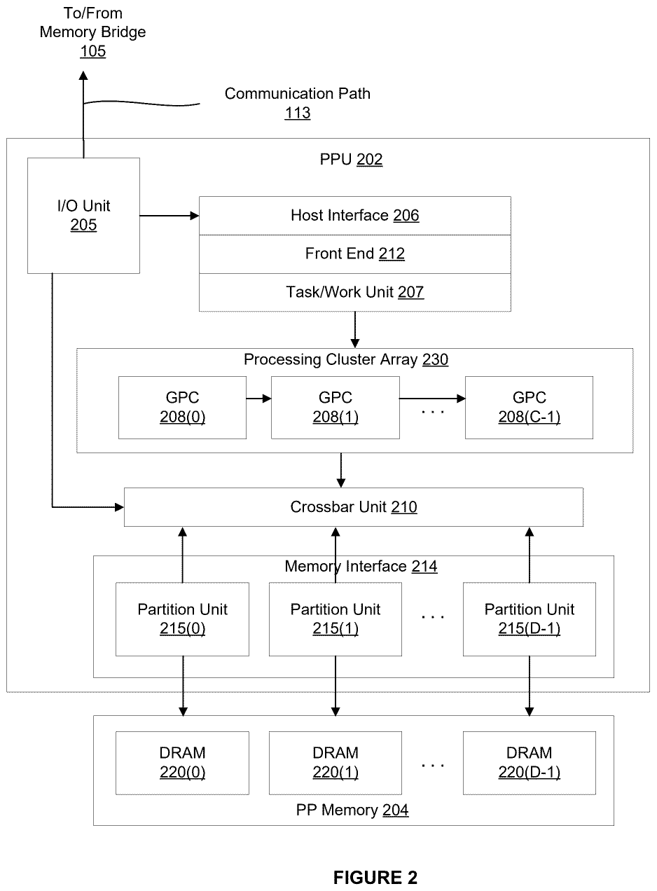

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to various embodiments of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C □ 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D □ 1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

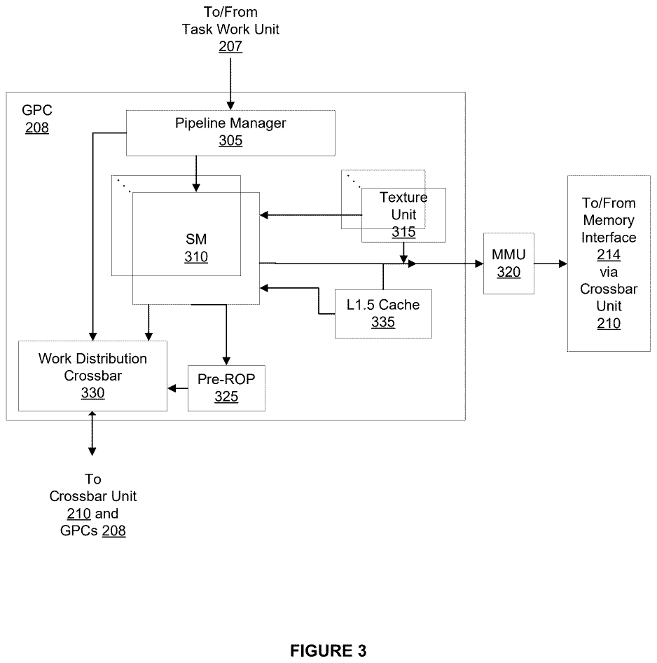

FIG. 3 is a block diagram of a GPC 208 included in PPU 202 of FIG. 2, according to various embodiments of the present invention. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M 1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the present invention.

### Reconstructed 3D Scene Generation and Use

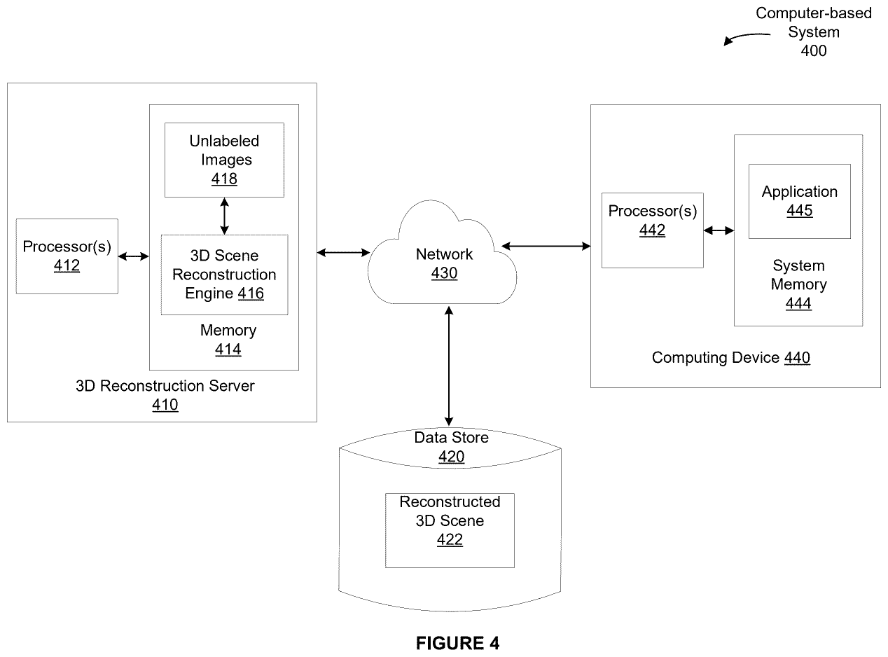

FIG. 4 illustrates a block diagram of a computer-based system 400 configured to implement one or more aspects of the various embodiments. As shown, computer-based system 400 includes, without limitation, a 3D reconstruction server 410, a data store 420, a network 430, and a computing device 440. 3D reconstruction server 410 includes, without limitation, processor(s) 412 and a system memory 414. System memory 414 includes, without limitation, a 3D scene reconstruction engine 416 and unlabeled images 418. Computing device 440 includes, without limitation, processor(s) 442 and system memory 444. System memory 444 includes, without limitation, an application 445. Data store 420 stores, without limitation, reconstructed 3D scene 422. Each of 3D reconstruction server 410 and computing device 440 can include similar components, features, and/or functionality as the exemplary computer system 100, described above in conjunction with FIG. 1-3. Each of 3D reconstruction server 410 and computing device 440 can be any technically feasible type of computer system, including, without limitation, a server machine or a server platform.

3D reconstruction server 410 shown herein is for illustrative purposes only, and variations and modifications are possible without departing from the scope of the present disclosure. For example, the number and types of processors 412, the number of GPUs and/or other processing unit types, the number and types of system memories 414, and/or the number of applications included in the system memory 414 can be modified as desired. Further, the connection topology between the various units within 3D reconstruction server 410 can be modified as desired. In some embodiments, any combination of the processor(s) 412 and the system memory 414, and/or GPU(s) can be included in and/or replaced with any type of virtual computing system, distributed computing system, and/or cloud computing environment, such as a public, private, or a hybrid cloud system.

Processor(s) 412 receive user input from input devices, such as a keyboard or a mouse. Processor(s) 412 can be any technically feasible form of processing device configured to process data and execute program code. For example, any of processor(s) 412 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 412, or any combination of these different processors, such as a CPU working in cooperation with one or more GPUs. In various embodiments, the processor(s) 412 can issue commands that control the operation of one or more GPUs (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 414 of 3D reconstruction server 410 stores content, such as software applications and data, for use by processor(s) 412. System memory 414 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace system memory 414. The storage can include any number and type of external memories that are accessible to processor(s) 412. For example, and without limitation, the storage can include a Secure Digital Card, an external Flash memory, a portable compact disc read-only memory (CD-ROM), an optical storage device, a magnetic storage device, and/or any suitable combination of the foregoing.

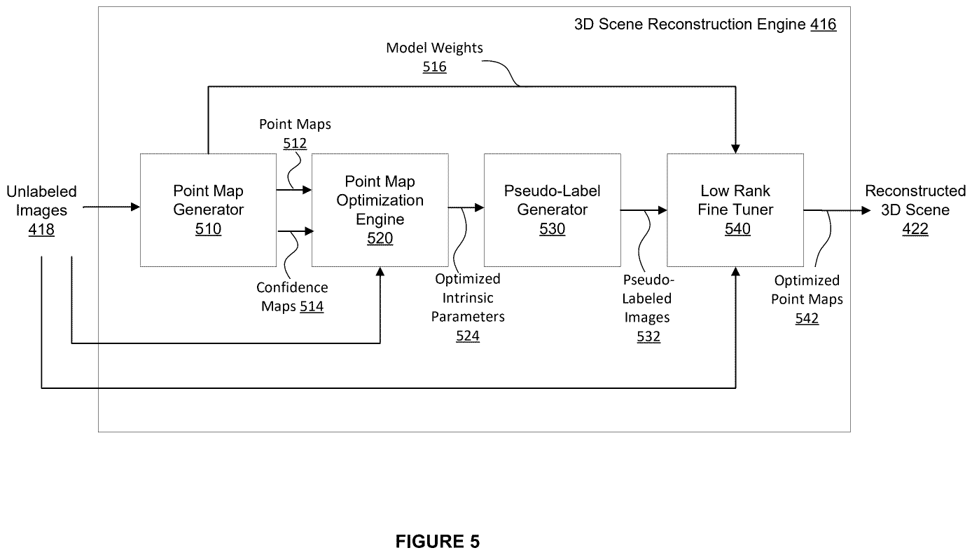

3D scene reconstruction engine 416 stored within system memory 414 is configured to generate reconstructed 3D scene 422 using unlabeled images 418. First, a point map and a corresponding confidence map are generated from each pair of unlabeled images 418. The point maps and the confidence maps are then optimized to generate refined point maps and calibrated confidence maps. Next, the refined point maps and calibrated confidence maps are used to generate pseudo-labels for each pair of unlabeled images 418. Each pair of pseudo-labeled images are then used to fine-tune a pre-trained vision transformer where a low rank decomposition is added to the model weights. For each new input pair of unlabeled images 418 of the same scene, a pair of optimized point maps are generated and used to produce reconstructed 3D scene 422. 3D scene reconstruction engine 416 then stores reconstructed 3D scene 422 in data store 420. Reconstructed 3D scene 422 can then be used in any suitable application, such as application 445 executing on computing device 440. The operations performed by 3D scene reconstruction engine 416 to generate reconstructed 3D scene 422 are described in greater detail below in conjunction with FIGS. 5-7.

Unlabeled images 418 are images with no information about the intrinsic or extrinsic camera parameters. Intrinsic camera parameters, such as focal length, are fixed to a particular camera setup. Extrinsic camera parameters define the location and orientation of the camera with respect to a particular coordinate system. Unlabeled images 418 can be obtained by any type of technically feasible camera or video capture device. For example, and without limitation, unlabeled images 418 can be obtained by a monocular camera such as a smartphone camera or a camera located in a vehicle. In various embodiments, unlabeled images 418 can include images of the same scene from multiple viewpoints. Although not shown in FIG. 4, unlabeled images 418 can be loaded by 3D scene reconstruction engine 416 from data store 420 and/or one or more other data repositories.

Data store 420 provides non-volatile storage for applications and data in 3D reconstruction server 410 and computing device 440. For example, and without limitation, training data, trained (or deployed) machine learning models and/or application data, unlabeled images 418, and reconstructed 3D scene 422 can be stored in the data store 420 for use by application 445. In some embodiments, data store 420 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 420 can be a network attached storage (NAS) and/or a storage area-network (SAN). Although shown as coupled to 3D reconstruction server 410 and computing device 440 via network 430, in various embodiments, 3D reconstruction server 410 or computing device 440 can include data store 420.

Network 430 includes any technically feasible type of communications network that allows data to be exchanged between 3D reconstruction server 410, computing device 440, data store 420 and external entities or devices, such as a web server or another networked computing device. For example, network 430 can include a wide area network (WAN), a local area network (LAN), a cellular network, a wireless (WiFi) network, and/or the Internet, among others.

Computing device 440 shown herein is for illustrative purposes only, and variations and modifications are possible without departing from the scope of the present disclosure. For example, the number and types of processor(s) 442, the number and types of system memories 444, and/or the number of applications included in the system memory 444 can be modified as desired. Further, the connection topology between the various units within computing device 440 can be modified as desired. In some embodiments, any combination of the processor(s) 442 and/or the system memory 444 can be included in and/or replaced with any type of virtual computing system, distributed computing system, and/or cloud computing environment, such as a public, private, or a hybrid cloud system. In various embodiments, computing device 440 can be implemented using any of the computing devices of FIGS. 1-3.

Similar to processor(s) 412, processor(s) 442 receive user input from input devices, such as a keyboard or a mouse. Processor(s) 442 can be any technically feasible form of processing device configured to process data and execute program code. For example, any of processor(s) 442 could be a CPU, a GPU, an ASIC, a FPGA, and so forth. In various embodiments any of the operations and/or functions described herein can be performed by processor(s) 442, or any combination of these different processors, such as a CPU working in cooperation with a one or more GPUs. In various embodiments, the one or more GPU(s) perform parallel processing task, such as matrix multiplications and/or the like in LLM model computations. Processor(s) 442 can also receive user input from input devices, such as a keyboard or a mouse and generate output on one or more displays.

Similar to system memory 414 of 3D reconstruction server 410, system memory 444 of computing device 440 stores content, such as software applications and data, for use by the processor(s) 442. The system memory 444 can be any type of memory capable of storing data and software applications, such as a RAM, ROM, EPROM, Flash ROM, or any suitable combination of the foregoing. In some embodiments, a storage (not shown) can supplement or replace the system memory 444. The storage can include any number and type of external memories that are accessible to processor(s) 442. For example, and without limitation, the storage can include a Secure Digital Card, an external Flash memory, a portable CD-ROM, an optical storage device, a magnetic storage device, and/or any suitable combination of the foregoing.

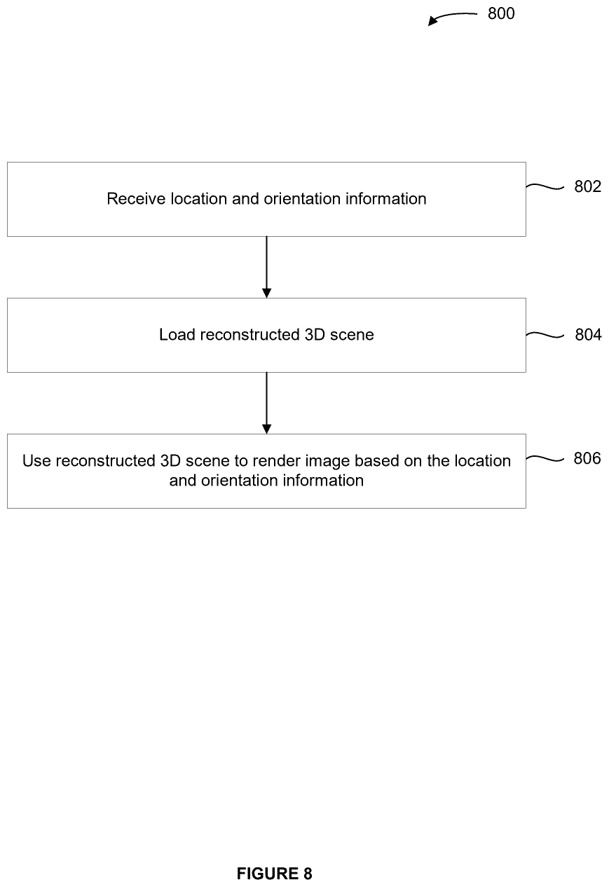

As shown, system memory 444 includes application 445. Application 445 accesses reconstructed 3D scene 422 from data store 420. Application 445 can be, without limitation, any type of navigation system, map, or route and direction assistant in an autonomous or manned vehicle and/or a hand-held device. For example, application 445 can load reconstructed 3D scene 422 and then use vehicle location and position information and reconstructed 3D scene 422 to render an image of the current location. In various embodiments, application 445 shows previews of a planned route, renders a view from specific coordinates, or annotates an image to displays landmarks or other points of interest. The operations performed by application 445 are described in greater detail below in conjunction with FIG. 8.

FIG. 5 is a more detailed illustration of 3D scene reconstruction engine 416 of FIG. 4, according to various embodiments. As shown, 3D scene reconstruction engine 416 includes, without limitation, point map generator 510, point maps 512, confidence maps 514, model weights 516, point map optimization engine 520, optimized intrinsic parameters 524, pseudo-label generator 530, pseudo-labeled images 532, low rank fine tuner 540, and optimized point maps 542. In operation, 3D scene reconstruction engine 416 receives unlabeled images 418 and generates reconstructed 3D scene 422. In various embodiments, unlabeled images 418 can include images of the same scene from multiple viewpoints.

Point map generator 510 can be any type of technically feasible pre-trained, supervised machine learning model. For example, in various embodiments, point map generator 510 can be a vision transformer with any suitable architecture. Supervised learning is a method of training machine learning models using a labeled dataset. In various embodiments, the input dataset to point map generator 510 is image or video data. More generally, the input dataset to point map generator 510 can include any technically feasible data that can be processed by a transformer-based model for computer vision. Point map generator 510 is trained to learn confidence predictions according to equation (1)

$${ℒ}_{conf} = {\sum }_{i , j} {\sum }_{v} {\sum }_{p} {C}_{p}^{v , i} {ℓ}_{regr} ( v , p ) - α {log C}_{p}^{v , i} \qquad ( 1 )$$

where

$${C}_{p}^{v , i}$$

is the confidence score for pixel p on image v from image pair (i, j), α is a constant, and [symbol] _{regr} is the pixel-wise distance between the predicted and ground truth maps according to equation (2):

$${ℓ}_{regr} ( v , p ) = ‖ \frac{1}{z} {X}_{p}^{v , i} - \frac{1}{\overline{z}} {\overline{X}}_{p}^{v , i} ‖ \qquad ( 2 )$$

where

$${X}_{p}^{v , i}$$

is the predicted point map

$${\overline{X}}_{p}^{v , i}$$

the ground truth point map, and z, z̅ are normalization factors. For each pair of input images, Iᵢ, Iⱼ from unlabeled images 418, point map generator 510 generates a pair of point maps 512 and a pair of confidence maps 514. Each pair of point maps 512 is expressed in the same camera coordinate frame of view as image Iᵢ and includes information on the scene geometry of input images Iᵢ, Iⱼ, the relation between pixels and scene points of input images Iᵢ, Iⱼ. Each pair of confidence maps 514 assigns each pixel of input images Iᵢ, Iⱼ a score between 0 and 1 representing how confident point map generator 510 is about that pixel.

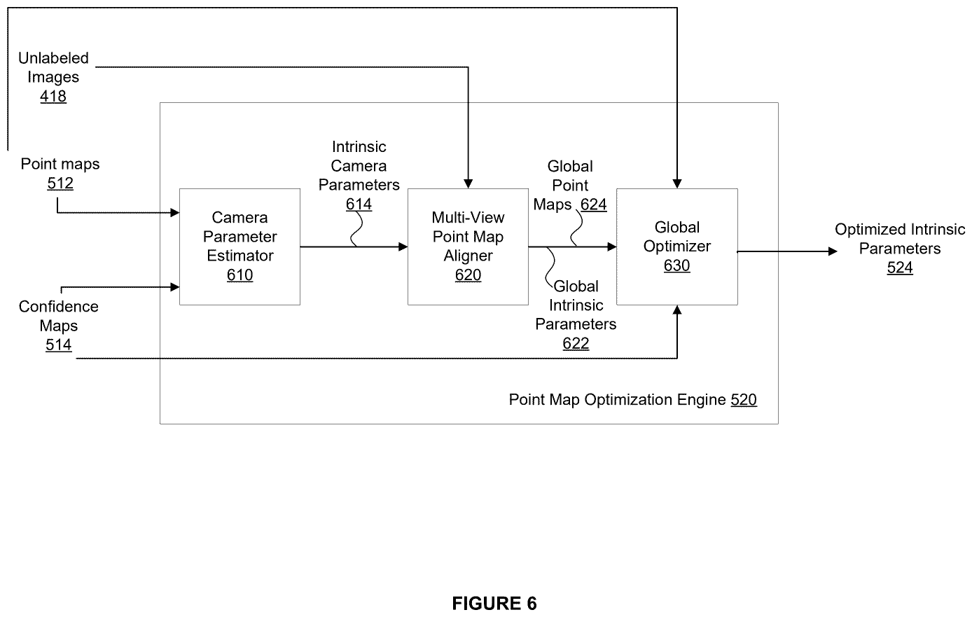

Point map optimization engine 520 receives as input point maps 512 and confidence maps 514 from point map generator 510, and unlabeled images 418. From point maps 512, point map optimization engine 520 recovers the intrinsic camera parameters of unlabeled images 418. Next, point map optimization engine 520 uses a multi-view point map alignment technique to generate global point maps and recover intrinsic camera parameters. Point map optimization engine 520 then optimizes the global point maps and intrinsic camera parameters to generate optimized intrinsic parameters 524. The operations of point map optimization engine 520 are described in further detail below in conjunction with FIG. 6.

FIG. 6 is a more detailed illustration of point map optimization engine 520 of FIG. 5, according to various embodiments. As shown, point map optimization engine 520 includes, without limitation, camera parameter estimator 610, intrinsic camera parameters 614, multi-view point map aligner 620, global point maps 624, global intrinsic parameters 622, and global optimizer 630. As noted above, point map optimization engine 520 receives unlabeled images 418, point maps 512, and confidence maps 514 and generates optimized intrinsic parameters 524. More specifically, point maps 512 and confidence maps 514 are input into camera parameter estimator 610.

Camera parameter estimator 610 recovers intrinsic camera parameters 614, including focal length, relative camera pose, and point map scales. Camera parameter estimator 610 determines the optimal focal length,

$${f}_{i}^{*} ,$$

of each camera used to take each unlabeled image 418 by solving the optimization problem according to equation (3):

$${f}_{i}^{*} = arg min \sum {C}_{p}^{i , i} ‖ ( {u}_{p}^{′} , {v}_{p}^{′} ) - {f}_{i} ( {X}_{p , 0}^{i , i} , {X}_{p , 1}^{i , i} ) / {X}_{p , 2}^{i , i} ‖ \qquad ( 3 )$$

where X^{i,i} is the point map and C^{i,i} is the corresponding confidence map associated to view i,

$$( {u}_{p}^{′} , {v}_{p}^{′} ) = ( {u}_{p} - \frac{W}{2} , {v}_{p} - \frac{H}{2} )$$

represents the re-centered image coordinates for pixel p and W×H the image resolution. The initial focal length fᵢ is estimated using a pinhole camera model with square pixels and principal points at image centers. Camera parameter estimator 610 determines the optimal relative camera poses and point map scales, (T_{i,j}, σ_{i,j})*, for each unlabeled image 418 by solving the optimization problem according to equation (4):

$${( {T}_{i , j} , {σ}_{i , j} )}^{*} = arg min \sum {C}_{p}^{i , i} {C}_{p}^{i , j} {‖ {σ}_{i , j} {T}_{i , j} {X}_{p}^{i , i} - {X}_{p}^{i , j} ‖}^{2} \qquad ( 4 )$$

where C^{i,i}, C^{i,j} are confidence maps and the initial relative camera poses T_{i,j} and the point map scales σ_{i,j} are estimated by comparing the point maps X^{i,i}, X^{i,j} using Procrustes alignment. Procrustes alignment is a technique of statistical shape analysis used to find the optimal rotations or reflection of one object with respect to another. The intrinsic camera parameters 614 are then passed to multi-view point map aligner 620.

Multi-view point map aligner 620 uses unlabeled images 418 and intrinsic camera parameters 614 to generate global point maps 624 and global intrinsic parameters 622. First, given a set {I₁ I₂, . . . , Iₙ} of images of a scene from unlabeled images 418, multi-view point map aligner 620 constructs a connectivity graph [symbol] , where each image of {I₁, I₂, . . . , Iₙ} forms a vertex of [symbol] and an edge between two vertices indicate that the images share some visual overlap. Next, the highest confidence spanning tree is extracted from the graph [symbol] . A spanning tree is a connected acyclic subgraph of [symbol] which includes all vertices of [symbol] . Multi-view point map aligner 620 then propagates intrinsic camera parameters 614 along the edges of the spanning tree to obtain global point maps 624 and global intrinsic parameters 622. Global intrinsic parameters 622 include one or more of focal length, image-pair scales, image-pair poses, and/or the like. All of the global intrinsic parameters 622 are expressed in a unified global coordinate system. Multi-view point map aligner 620 then passes global point maps 624 and global intrinsic parameters 622 to global optimizer 630.

Global optimizer 630 generates optimized intrinsic parameters 524 by minimizing the 3D projection error between the global point maps 624 and point maps 512 with added regularization term according to equation (5):

$${( T , σ , f , D , 𝒲 )}^{*} = arg min {\sum }_{ε} {\sum }_{v} {\sum }_{p} {w}_{p}^{v , i} ‖ {e}_{p}^{v , i} ‖ + {μ ( \sqrt{{w}_{p}^{v , i}} - \sqrt{{C}_{p}^{v , i}} )}^{2} \qquad ( 5 )$$

where

$${w}_{p}^{v , i}$$

is an optimizable weight term,

$${e}_{p}^{v , i}$$

represents the pixel-wise residual error and μ is a constant. The pixel-wise residual error

$${e}_{p}^{v , i}$$

is given according to equation (6):

$${e}_{p}^{v , i} = {χ}_{p}^{v} = {σ}^{( i , j )} {T}^{( i , j )} {X}_{p}^{v , i} \qquad ( 6 )$$

where

$${χ}_{p}^{v}$$

is a global point map, σ^{(i,j)} are the image-pair scales, T^{(i,j)} are image-pair poses, and

$${X}_{p}^{v , i}$$

is a point map. The global point maps 624 can be parameterized according to equation (7):

$${χ}_{p}^{v} = {T}_{v} {K}_{v}^{- 1} {{D}_{p} ( {u}_{p} , {v}_{p} , 1 )}^{T} = \frac{{T}_{v} {D}_{p}}{{f}_{v}} {( {u}_{p}^{′} , {v}_{p}^{′} , 1 )}^{T} \qquad ( 7 )$$

where Tᵥ is the camera pose, Kᵥ is the associated camera intrinsics, and fᵥ is the focal length for a view v, and Dₚ is the depth value for pixel p. The depth value Dₚ is initially estimated according to equation (8):

$${D}_{p} = \frac{{f}_{v} {B}_{i , j}}{{d}_{i , j}} \qquad ( 8 )$$

where fᵥ is the focal length, B_{i,j} measures the distance between the cameras used for images Iᵢ, Iⱼ, and d_{i,j} measures the horizontal shift of pixel p between images Iᵢ, Iⱼ. Thus, the pixel-wise residual error

$${e}_{p}^{v , i}$$

is written according to equation (8):

$${e}_{p}^{v , i} = \frac{{T}_{v} {D}_{p}}{{f}_{v}} {( {u}_{p}^{′} , {v}_{p}^{′} , 1 )}^{T} - {σ}^{( i , j )} {T}^{( i , j )} {X}_{p}^{v , i} \qquad ( 9 )$$

During optimization, global optimizer 630 alternates between updating the parameters T, σ, f, D of equation (3) by gradient descent and updating the weights [symbol] according to the rule given in equation (9):

$${w}_{p}^{v , i} = \frac{{c}_{p}^{v , i}}{{( 1 + \frac{‖ {e}_{p}^{v , i} ‖}{μ} )}^{2}} \qquad ( 10 )$$

where

$${C}_{p}^{v , i}$$

is the confidence map corresponding to the point map

$${X}_{p}^{v , i} .$$

After completing the optimization, global optimizer 630 generates optimized intrinsic parameters 524. Global optimizer 630 then passes optimized intrinsic parameters 524 to pseudo-label generator 530.

Referring back to FIG. 5, pseudo-label generator 530 receives optimized intrinsic parameters 524 from point map optimization engine 520. Pseudo-label generator 530 computes pseudo-labels for each image pair from unlabeled images 418. First, pseudo-label generator 530 uses optimized intrinsic parameters 524 to generate a pair of refined point maps corresponding to the image pairs from unlabeled images 418 by back-projecting the optimized depth values

$${D}_{p}^{*} ,$$

determined according to equation (5) and transforming the points to the image pair coordinate frame according to equation (10):

$${\tilde{X}}_{p}^{j , i} = \frac{{T}_{i}^{* - 1} {T}_{j}^{*} {D}_{p}^{*}}{{f}_{j}^{*}} {( {u}_{p}^{′} , {v}_{p}^{′} , 1 )}^{T} \qquad ( 11 )$$

where

$${\tilde{X}}_{p}^{j , i}$$

is a refined point map,

$${T}_{j}^{*}$$

is the corresponding optimized image pose,

$${D}_{p}^{*} ,$$

is the optimized depth value at pixel p, and

$${f}_{j}^{*}$$

the optimized focal length, respectively, and

$${w}_{p}^{* j , i}$$

is the optimized weight parameter. Next, pseudo-label generator 530 thresholds the refined point maps with a confidence cutoff, w_{cutoff}, according to equation (11):

$${\tilde{X}}_{p}^{j , i} = \frac{{T}_{i}^{* - 1} {T}_{j}^{*} {D}_{p}^{*}}{{f}_{j}^{*}} {( {u}_{p}^{′} , {v}_{p}^{′} , 1 )}^{T} , where p ∈ \{ p \vert {w}_{p}^{* j , i} > {w}_{cutoff} \} \qquad ( 12 )$$

where the refined point maps with

$$p ∈ \{ p \vert {w}_{p}^{* j , i} > {w}_{cutoff} \}$$

are considered to have high calibrated prediction confidence. Pseudo-label generator 530 retains the high-confidence refined point maps as pseudo-labels to create pseudo-labeled images 532. Pseudo-label generator 530 then passes pseudo-labeled images 532 to low rank fine tuner 540.

Low rank fine tuner 540 can be any type of technically feasible pre-trained, machine learning model with the same architecture and trained on the same dataset as point map generator 510. First, low rank fine tuner 540 receives model weights 516 from point map generator 510. For each model weight 516 W₀ of size d×k from point map generator 510, low rank fine tuner 540 adds a low rank decomposition BA, where B is a matrix of size d×r, A is a matrix of size r×k, and Rank(BA)=r<<min(d, k). Low rank fine tuner 540 uses pseudo-labeled images 532 received from pseudo-label generator 530 to train the weights ΔW=W₀+BA. During training, W₀ does not receive gradient updates, while A and B contain trainable parameters. In various embodiments, A is initialized as a random Gaussian matrix and B is initialized to be a matrix with all entries equal to zero. Low rank fine tuner 540 can use any feasible training technique to train the low rank matrices A and B, such as stochastic gradient descent with backpropagation or adaptive moment estimation (Adam). Then, for any previously unseen pair of images from unlabeled images 418, low rank fine tuner 540 generates a pair of optimized point maps 542. The optimized point maps 542 are used to generate reconstructed 3D scene 422 that closely matches the unlabeled images 418.

### Generating Reconstructed 3D Scenes

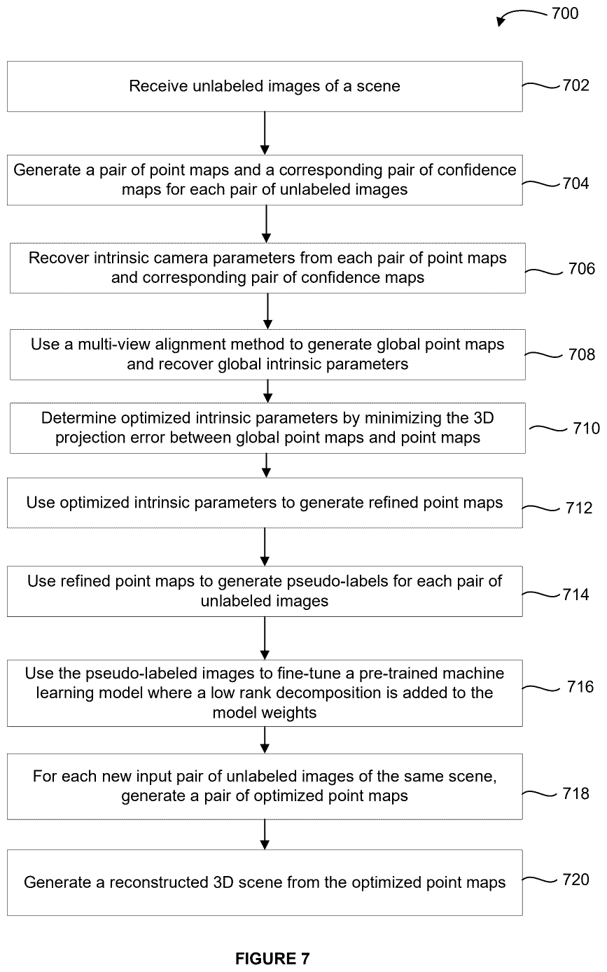

FIG. 7 is a flow diagram of method steps for generating reconstructed 3D scene, according to various embodiments. Although the method steps are described in conjunction with the systems of FIGS. 1-6, persons skilled in the art will understand that any system configured to perform the method steps, in any order, falls within the scope of the various embodiments.

As shown, a method 700 begins at step 702, where 3D scene reconstruction engine 416 receives unlabeled images 418 of a scene. Unlabeled images 418 are images with no information about the intrinsic or extrinsic camera parameters. Unlabeled images 418 can be obtained by any type of technically feasible camera or video capture device. For example, and without limitation, unlabeled images 418 can be obtained by a monocular camera such as a smartphone camera or a camera located in a vehicle. In various embodiments, unlabeled images 418 can include images of the same scene from multiple viewpoints.

At step 704, point map generator 510 generates a pair of point maps 512 and a corresponding pair of confidence maps 514 for each pair of unlabeled images 418. More specifically, point map generator 510 can be any technically feasible pre-trained, supervised machine learning model trained to generate point maps and confidence maps from input image or video data. For example, in various embodiments, point map generator 510 can be a vision transformer with any suitable architecture trained using equations (1) and (2). For each pair of input images from unlabeled images 418, point map generator 510 generates a pair of point maps 512 and a pair of confidence maps 514. Each pair of point maps 512 includes information on the scene geometry of the input images and information on the relation between pixels and scene points of the input images. Each pair of confidence maps 514 assigns each pixel of the pair of input images a score between 0 and 1 representing how confident point map generator 510 is about the classification or prediction at that pixel.

At step 706, camera parameter estimator 610 recovers intrinsic camera parameters from each pair of point maps 512 and corresponding pair of confidence maps 514. Intrinsic camera parameters 614 include focal length, relative camera pose, and point map scales. More specifically, camera parameter estimator 610 determines the optimal focal length of each camera used to take each unlabeled image 418 by solving the optimization problem according to equation (3). Camera parameter estimator 610 determines the optimal relative camera poses and point map scales for each unlabeled image 418 by solving the optimization problem according to equation (4).

At step 708, multi-view point map aligner 620 uses a multi-view alignment method to generate global point maps 624 and recover global intrinsic parameters 622. First, given a set of images of a scene from unlabeled images 418, multi-view point map aligner 620 constructs a connectivity graph [symbol] , where each image from the set forms a vertex of [symbol] and an edge between two vertices indicate that the images share some visual overlap. Next, the highest confidence spanning tree is extracted from the graph [symbol] . Multi-view point map aligner 620 then propagates intrinsic camera parameters 614 along the edges of the spanning tree to obtain global point maps 624 and global intrinsic parameters 622. Global intrinsic parameters 622 include focal length, image-pair scales, and image-pair poses, all expressed in a unified global coordinate system.

At step 710, global optimizer 630 determines the optimized intrinsic parameters 524 by minimizing the 3D projection error between the global point maps 624 and point maps 512. Global optimizer 630 minimizes the 3D projection error between the global point maps 624 and point maps 512 according to equation (5). Equation (5) includes a weight term, a pixel wise residual error term, and a regularization term. The pixel wise residual error is given according to equation (6). The global point maps 624 in equation (6) can be parameterized using global intrinsic parameters 622 given according to equation (7) and depth values given according to equation (8), thus allowing the pixel-wise residual error to be written according to equation (9). During optimization, global optimizer 630 alternates between updating the parameters T, σ, f, D of equation (5) by gradient descent and updating the weight term according to the rule given in equation (10).

At step 712 pseudo-label generator 530 uses optimized intrinsic parameters 524 to generate refined point maps. More specifically, pseudo-label generator 530 uses optimized intrinsic parameters 524 to generate refined point maps corresponding to the image pairs from unlabeled images 418 by back-projecting the optimized depth values and transforming the points to the image pair coordinate frame according to equation (11).

At step 714, pseudo-label generator 530 uses refined point maps to generate pseudo-labels for each pair of unlabeled images 418. Pseudo-label generator 530 thresholds the refined point maps with a confidence cutoff according to equation (12), where the refined point maps with

$$p ∈ \{ p \vert {w}_{p}^{* j , i} > {w}_{cutoff} \}$$

are considered to have high calibrated prediction confidence. Pseudo-label generator 530 then retains the high-confidence refined point maps as pseudo-labels to create pseudo-labeled images 532.

At step 716, low rank fine tuner 540 uses pseudo-labeled images 532 to fine-tune a pre-trained machine learning model where a low rank decomposition is added to the model weights 516. Low rank fine tuner 540 can be any type of technically feasible pre-trained, machine learning model with the same architecture and trained on the same dataset as point map generator 510. First, low rank fine tuner 540 adds a low rank decomposition BA, where B is a matrix of size d×r, A is a matrix of size r×k, and Rank(BA)=r<<min(d, k) to each model weight 516, W₀, of size d×k from point map generator 510. Low rank fine tuner 540 then uses pseudo-labeled images 532 received from pseudo-label generator 530 to train the weights ΔW=W₀+BA. During training, W₀ does not receive gradient updates, while A and B contain trainable parameters. In various embodiments, A is initialized as a random Gaussian matrix and B is initialized to be a matrix with all entries equal to zero. Low rank fine tuner 540 can use any feasible training technique to train the low rank matrices A and B, such as stochastic gradient descent with backpropagation, Adam, and/or the like.

At step 718, for each new input pair of unlabeled images 418 of the same scene, low rank fine tuner 540 generates a pair of optimized point maps 542. First, each new pair of unlabeled images 418 is input to the pre-trained machine learning model with low rank model weights ΔW=W₀+BA. For each input pair of unlabeled images 418 the pre-trained machine learning model with low rank weights outputs a pair of optimized point maps 542.

At step 720, low rank fine tuner 540 generates reconstructed 3D scene 422 from the optimized point maps 542. From each pair of optimized point maps 542 generated by low rank fine tuner 540, information from the intrinsic camera parameters, including information of the scene geometry of the input images and information on the relation between pixels and scene points of the input images is recovered. From the intrinsic parameters recovered from the optimized point maps 542, low rank fine tuner 540 generates reconstructed 3D scene 422 which best match unlabeled images 418 for the 3D scene.

### Using Reconstructed 3D Scene

FIG. 8 is a flow diagram of method steps for using reconstructed 3D scene, according to various embodiments. Although the method steps are described in conjunction with the systems of FIGS. 1-6, persons skilled in the art will understand that any system configured to perform the method steps, in any order, falls within the scope of the various embodiments.

As shown, a method 800 begins at step 802, where application 445 receives location and orientation information. The location and orientation information can include a position of a device on which application 445 is executing, an orientation of the device, and/or a direction of travel for the device. For example, when the device is located in a vehicle, the location and orientation information can indicate where the vehicle is located and an orientation direction of the vehicle. Application 445 can be, without limitation, any type of navigation system, map, or route and direction assistant in an autonomous or manned vehicle or a hand-held device.

At step 804, application 445 loads reconstructed 3D scene 422. Application 445 accesses data store 420 and loads reconstructed 3D scene 422. Application 445 can load reconstructed 3D scene 422 from any storage device, such as data store 420. Reconstructed 3D scene 422 can include any reconstructed 3D scene 422, such as reconstructed 3D scene 422 generated using method 700. In some embodiments, application 445 can load any number of reconstructed 3D scenes 422.

At step 806, application 445 uses reconstructed 3D scene 422 to render an image based on the location and orientation information. For example, application 445 uses vehicle location and position information and reconstructed 3D scene 422 to render an image of the current location. In various embodiments, application 445 uses the location and orientation of the device in which application 445 is executing to determine a corresponding viewing perspective in reconstructed 3D scene 422. Application 445 then uses the corresponding viewing perspective to render a view of the reconstructed 3D scene captured by reconstructed 3D scene 422. The view can assist a user during navigation by showing images of the 3D environment. Additionally or alternatively, the images can be further annotated to identify landmarks or other points of interest.

In sum, a 3D scene is reconstructed from a set of unlabeled 2D images. First, for each pair of 2D images from a set of unlabeled 2D images, a pre-trained vision transformer generates a corresponding pair of point maps and confidence maps. Next, the point maps are optimized to refine multi-view predictions and calibrate prediction confidence. Then, the refined point maps with high calibrated prediction confidence are used to generate pseudo-labels for each pair of 2D images from the set of unlabeled 2D images. Each pair of pseudo-labeled 2D images is then used to fine-tune the pre-trained vision transformer, where a low rank decomposition is added to the weights of the pre-trained vision transformer. During fine-tuning, the low rank decomposition matrices are optimized, while the weights of the pre-trained vision transformer are frozen and do not receive gradient updates. For each new input pair of 2D images from the same scene, the fine-tuned vision transformer outputs point maps which are used to reconstruct a 3D scene that closely matches the originally collected unlabeled 2D images.

At least one technical advantage of the disclosed techniques relative to the prior art is that, with the disclosed techniques, accurate reconstruction of 3D scenes can be generated from 2D images without having information about the intrinsic or extrinsic camera parameters. The disclosed techniques can generate accurate reconstruction of 3D scenes without manual labeling, eliminating the need to generate large labeled datasets to generate the reconstructed 3D scene. This allows the disclosed techniques to be used while new 2D images are being received from imaging devices and allows a 3D scene to be reconstructed based on these new 2D images. In addition, with the disclosed techniques accurate reconstruction of 3D scenes can be generated without having to train specialized neural models, which significantly reduces the computing resources used to generate the reconstructed 3D scene. These technical advantages represent one or more technological improvements over prior art approaches.

1. In some embodiments, a computer-implemented method for generating a 3D environment map comprises receiving a plurality of unlabeled images of a scene, generating a pair of point maps and a pair of confidence maps for a first pair of unlabeled images of the plurality of unlabeled images, determining intrinsic camera parameters for the first pair of unlabeled images, refining the pair of point maps based on the intrinsic camera parameters to generate a refined pair of point maps, generating pseudo-labels for the first pair of unlabeled images based on the refined pair of point maps and the pair of confidence maps, and fine tuning a pretrained machine learning model based on the pseudo-labels to generate a fine-tuned machine learning model.

2. The computer-implemented method of clause 1, further comprising receiving a pair of images of the scene, generating a pair of optimized points maps for the pair of images using the fine-tuned machine learning model, and generating a 3D reconstruction of the scene based on the optimized point maps.

3. The computer-implemented method of clauses 1 or 2, wherein generating the pair of point maps and the pair of confidence maps comprises presenting the first pair of unlabeled images to a vision transformer.

4. The computer-implemented method of any of clauses 1-3, wherein determining the intrinsic camera parameters comprises applying multi-view alignment to the plurality of unlabeled images to generate global point maps, and minimizing projection error between the global point maps and the pair of point maps.

5. The computer-implemented method of any of clauses 1-4, wherein the intrinsic camera parameters include a least one of focal length, image-pair scale, and image-pair pose.

6. The computer-implemented method of any of clauses 1-5, wherein the plurality of unlabeled images comprises 2D images.

7. The computer-implemented method of any of clauses 1-6, wherein refining the pair of point maps based on the intrinsic camera parameters to generate the refined pair of point maps comprises back-projecting optimized depth values, and transforming points in the pair of point maps to an image pair coordinate frame.

8. The computer-implemented method of any of clauses 1-7, wherein generating the pseudo-labels comprises selecting points in the refined pair of point maps by applying a confidence cutoff to confidence scores in the pair of confidence maps.

9. The computer-implemented method of any of clauses 1-8, wherein entries in the pair of point maps include at least one of image pose, depth of a pixel, or focal length of a camera used to capture a corresponding unlabeled image.

10. The computer-implemented method of any of clauses 1-9, wherein fine tuning the pretrained machine learning model comprises adding a low rank decomposition to weights of the pretrained machine learning model.

11. The computer-implemented method of any of clauses 1-10, wherein the pretrained machine learning model comprises a vision transformer.

12. The computer-implemented method of any of clauses 1-11, wherein the pretrained machine learning model has a same architecture and is trained using a same dataset as a second pre-trained machine learning model used to generate the pair of point maps and the pair of confidence maps.

13. In some embodiments, one or more non-transitory computer-readable media store instructions that, when executed by at least one processor, cause the at least one processor to perform the steps of receiving a plurality of unlabeled images of a scene, generating a pair of point maps and a pair of confidence maps for a first pair of unlabeled images of the plurality of unlabeled images, determining intrinsic camera parameters for the first pair of unlabeled images, refining the pair of point maps based on the intrinsic camera parameters to generate a refined pair of point maps, generating pseudo-labels for the first pair of unlabeled images based on the refined pair of point maps and the pair of confidence maps, and fine tuning a pretrained machine learning model based on the pseudo-labels to generate a fine-tuned machine learning model.

14. The one or more non-transitory computer-readable media of clause 13, wherein the steps further comprise receiving a pair of images of the scene, generating a pair of optimized points maps for the pair of images using the fine-tuned machine learning model, and generating a 3D reconstruction of the scene based on the optimized point maps.

15. The one or more non-transitory computer-readable media of clauses 13 or 14, wherein determining the intrinsic camera parameters comprises applying multi-view alignment to the plurality of unlabeled images to generate global point maps, and minimizing projection error between the global point maps and the pair of point maps.

16. The one or more non-transitory computer-readable media of any of clauses 13-15, wherein refining the pair of point maps based on the intrinsic camera parameters to generate the refined pair of point maps comprises back-projecting optimized depth values, and transforming points in the pair of point maps to an image pair coordinate frame.

17. The one or more non-transitory computer-readable media of any of clauses 13-16, wherein generating the pseudo-labels comprises selecting points in the refined pair of point maps by applying a confidence cutoff to confidence scores in the pair of confidence maps.

18. The one or more non-transitory computer-readable media of any of clauses 13-17, wherein entries in the pair of point maps include at least one of image pose, depth of a pixel, or focal length of a camera used to capture a corresponding unlabeled image.

19. The one or more non-transitory computer-readable media of any of clauses 13-18, wherein fine tuning the pretrained machine learning model comprises adding a low rank decomposition to weights of the pretrained machine learning model.

20. In some embodiments, a system comprises one or more memories storing instructions, and one or more processors that are coupled to the one or more memories and, when executing the instructions, are configured to receiving a plurality of unlabeled images of a scene, generating a pair of point maps and a pair of confidence maps for a first pair of unlabeled images of the plurality of unlabeled images, determining intrinsic camera parameters for the first pair of unlabeled images, refining the pair of point maps based on the intrinsic camera parameters to generate a refined pair of point maps, generating pseudo-labels for the first pair of unlabeled images based on the refined pair of point maps and the pair of confidence maps, and fine tuning a pretrained machine learning model based on the pseudo-labels to generate a fine-tuned machine learning model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a 3D environment map, the method comprising:
receiving a plurality of unlabeled images of a scene;
generating a pair of point maps and a pair of confidence maps for a first pair of unlabeled images of the plurality of unlabeled images;
determining intrinsic camera parameters for the first pair of unlabeled images;
refining the pair of point maps based on the intrinsic camera parameters to generate a refined pair of point maps;
generating pseudo-labels for the first pair of unlabeled images based on the refined pair of point maps and the pair of confidence maps; and
fine tuning a pretrained machine learning model based on the pseudo-labels to generate a fine-tuned machine learning model.

2. The computer-implemented method of claim 1, further comprising:
receiving a pair of images of the scene;
generating a pair of optimized points maps for the pair of images using the fine-tuned machine learning model; and
generating a 3D reconstruction of the scene based on the optimized point maps.

3. The computer-implemented method of claim 1, wherein generating the pair of point maps and the pair of confidence maps comprises presenting the first pair of unlabeled images to a vision transformer.

4. The computer-implemented method of claim 1, wherein determining the intrinsic camera parameters comprises:
applying multi-view alignment to the plurality of unlabeled images to generate global point maps; and
minimizing projection error between the global point maps and the pair of point maps.

5. The computer-implemented method of claim 1, wherein the intrinsic camera parameters include a least one of focal length, image-pair scale, and image-pair pose.

6. The computer-implemented method of claim 1, wherein the plurality of unlabeled images comprises 2D images.

7. The computer-implemented method of claim 1, wherein refining the pair of point maps based on the intrinsic camera parameters to generate the refined pair of point maps comprises:
back-projecting optimized depth values; and
transforming points in the pair of point maps to an image pair coordinate frame.

8. The computer-implemented method of claim 1, wherein generating the pseudo-labels comprises selecting points in the refined pair of point maps by applying a confidence cutoff to confidence scores in the pair of confidence maps.

9. The computer-implemented method of claim 1, wherein entries in the pair of point maps include at least one of image pose, depth of a pixel, or focal length of a camera used to capture a corresponding unlabeled image.

10. The computer-implemented method of claim 1, wherein fine tuning the pretrained machine learning model comprises adding a low rank decomposition to weights of the pretrained machine learning model.

11. The computer-implemented method of claim 1, wherein the pretrained machine learning model comprises a vision transformer.

12. The computer-implemented method of claim 1, wherein the pretrained machine learning model has a same architecture and is trained using a same dataset as a second pre-trained machine learning model used to generate the pair of point maps and the pair of confidence maps.

13. One or more non-transitory computer-readable media storing instructions that, when executed by at least one processor, cause the at least one processor to perform the steps of:
receiving a plurality of unlabeled images of a scene;
generating a pair of point maps and a pair of confidence maps for a first pair of unlabeled images of the plurality of unlabeled images;
determining intrinsic camera parameters for the first pair of unlabeled images;
refining the pair of point maps based on the intrinsic camera parameters to generate a refined pair of point maps;
generating pseudo-labels for the first pair of unlabeled images based on the refined pair of point maps and the pair of confidence maps; and
fine tuning a pretrained machine learning model based on the pseudo-labels to generate a fine-tuned machine learning model.

14. The one or more non-transitory computer-readable media of claim 13, wherein the steps further comprise:
receiving a pair of images of the scene;
generating a pair of optimized points maps for the pair of images using the fine-tuned machine learning model; and
generating a 3D reconstruction of the scene based on the optimized point maps.

15. The one or more non-transitory computer-readable media of claim 13, wherein determining the intrinsic camera parameters comprises:
applying multi-view alignment to the plurality of unlabeled images to generate global point maps; and
minimizing projection error between the global point maps and the pair of point maps.

16. The one or more non-transitory computer-readable media of claim 13, wherein refining the pair of point maps based on the intrinsic camera parameters to generate the refined pair of point maps comprises:
back-projecting optimized depth values; and
transforming points in the pair of point maps to an image pair coordinate frame.

17. The one or more non-transitory computer-readable media of claim 13, wherein generating the pseudo-labels comprises selecting points in the refined pair of point maps by applying a confidence cutoff to confidence scores in the pair of confidence maps.

18. The one or more non-transitory computer-readable media of claim 13, wherein entries in the pair of point maps include at least one of image pose, depth of a pixel, or focal length of a camera used to capture a corresponding unlabeled image.

19. The one or more non-transitory computer-readable media of claim 13, wherein fine tuning the pretrained machine learning model comprises adding a low rank decomposition to weights of the pretrained machine learning model.

20. A system, comprising:
one or more memories storing instructions; and
one or more processors that are coupled to the one or more memories and, when executing the instructions, are configured to:
receiving a plurality of unlabeled images of a scene;
generating a pair of point maps and a pair of confidence maps for a first pair of unlabeled images of the plurality of unlabeled images;
determining intrinsic camera parameters for the first pair of unlabeled images;
refining the pair of point maps based on the intrinsic camera parameters to generate a refined pair of point maps;
generating pseudo-labels for the first pair of unlabeled images based on the refined pair of point maps and the pair of confidence maps; and
fine tuning a pretrained machine learning model based on the pseudo-labels to generate a fine-tuned machine learning model.
